(19) United States
(12) Patent Application Publication
(10) Pub. No.: US 2021/0182665 A1
(43) Pub. Date: Jun. 17, 2021

(54) SENSOR DEVICE FOR CLASSIFICATION OF DATA

(71) Applicant: Imperial College of Science, Technology and Medicine, London (GB)

(72) Inventor: Thomas HEINIS, London (GB)

(73) Assignee: Imperial College of Science, Technology and Medicine, London (GB)

(21) Appl. No.: 16/760,878

(22) PCT Filed: Nov. 2, 2018
(86) PCT No.: PCT/GB2018/053185

§ 371 Date: Apr. 30, 2020

(30) Foreign Application Priority Data
Nov. 2, 2017 (GB) 1718164.5

(51) Int. Cl. G06N 3/08; G06K 9/62; G06F 7/57; G06F 7/483

(52) U.S. Cl. CPC G06N 3/08; G06K 9/6268; G06F 7/483; G06F 7/57; G06K 9/6202

(57) ABSTRACT

A sensor device comprising one or more sensors configured to measure data, a controller and memory. The controller comprises an arithmetic-logic unit “ALU”. The controller is configured to cause the ALU to carry out computations for implementing an artificial neural network “ANN” comprising a network of interconnected nodes. The memory is coupled to the ALU, and is configured to store integers representing weights associated with interconnects between the nodes. The controller is operable to implement the ANN to: receive data measured by the one or more sensors; and determine a classification of the data based on the network of interconnected nodes and the weights associated with the interconnects.

### BACKGROUND

A sensor device comprises at least one sensor which measures and records data over time. Sensor devices have become increasingly small, are being used in more and more applications and can measure a variety of different parameters. Typically, a sensor device may be relatively resource constrained. For example, one or more of a memory capacity, a processing power and/or a power source of a sensor device may be limited. Resources of a sensor device may, for example, be limited by factors such as the size, weight and/or cost of the device.

To interpret data measured by a sensor device, the data may be analysed. For example, measured data may be analysed in order to classify the data. The classification of the data may be a useful output, which might for example be stored, presented to a user and/or transmitted to another device. In some applications, the raw measured data on which the analysis is based may, after a period of time, be deleted and only the results of the analysis may be stored, displayed and/or transmitted.

One example of a sensor device is a wearable activity monitoring device (such as a watch-type device) designed to record activity information associated with a user. The sensor device might, for example, include one or more accelerometers arranged to measure acceleration of the device whilst being worn by a user. The acceleration data may be analysed in order to classify the data to determine a type of activity (such as, for example walking, running, cycling etc.) which the user is performing. The classification of the activity might, for example, be stored on the device, displayed to a user and/or transmitted to an external device. The acceleration data itself may then be deleted.

In another example, the sensor device may be an environmental sensor node designed to collect environmental data such as temperature and pressure. The sensor node might, for example, form part of a distributed sensor network. The data may be analysed in order to classify the data. A classification of the data may then be stored and/or transmitted to an external device and the raw environmental data may be deleted.

Data collected by a sensor device can either be analysed locally on resources which form part of the sensor device or transmitted to an external device and analysed there. For example, collected data may be transmitted to a server for analysis on the server.

The approach which is taken may depend, at least in part, on the resources available on the sensor device, which may be limited. A sensor device might, for example, be a portable device and may be powered by a battery. The capabilities of the sensor device may therefore be limited by the capacity of the battery used to power the sensor device. Furthermore, one or more other resources available to a sensor device may also be limited by factors such as the size, weight and/or cost of the device. For example, available memory and/or processing power which is available in a sensor device may be limited.

Transmitting the data measured by sensors to an external location for analysis can be both time and power inefficient. The raw measured data itself may, for example, comprise relatively large amounts of data, which may require substantial power and processing resources to transmit to an external device. Often the data is transmitted over a wireless communications channel with typically limited bandwidth which can therefore limit the speed of transfer. Furthermore, the wireless transmission of data itself can be power intensive and can therefore quickly drain the battery of a battery powered sensor device.

For these and/or other reasons it may therefore be desirable to perform at least some of the analysis locally on a sensor device. However, performing the analysis locally on a sensor device may require a given processing power and/or memory capacity to be available locally on the device. Furthermore, performing local analysis serves to drain the battery of the device. Performing the analysis locally on a resource limited device may, in some applications, therefore limit the type and quality of analysis which is possible according to the resource limitations of the device.

It is in this context that the present invention is devised.

### SUMMARY OF INVENTION

Recently, artificial neural networks have emerged which have shown improved classification accuracy, i.e., the ability to detect patterns in data efficiently and correctly. However, implementing an artificial neural network of a sufficient size to accurately classify data may be a relatively resource intensive task. Difficulties may therefore arise when attempting to implement an artificial neural network to classify data on a resource limited sensor device.

It has been realised that by using an arithmetic logic unit to carry out computations for implementing an artificial neural network, the power efficiency with which an artificial neural network can be implemented can be significantly improved. Furthermore, by using an integer representation of at least some of the components of the artificial neural network the memory footprint of an artificial neural network of a given size can be reduced. This advantageously allows the size of an artificial neural network which can be implemented on a given resource limited sensor device to be increased, thereby leading to an increase in the accuracy with which data can be classified.

According to a first aspect of the invention, there is provided a sensor device comprising: one or more sensors configured to measure data; a controller comprising an arithmetic-logic unit “ALU”, wherein the controller is configured to cause the ALU to carry out computations for implementing an artificial neural network “ANN” comprising a network of interconnected nodes; and memory coupled to the ALU, and configured to store integers representing weights associated with interconnects between the nodes; wherein the controller is operable to implement the ANN to: receive data measured by the one or more sensors; and determine a classification of the data based on the network of interconnected nodes and the weights associated with the interconnects.

An ALU is typically more energy efficient than a floating point unit (FPU) and/or is able to carry out a given computation faster than an FPU. Using an ALU to carry out arithmetic for implementing an ANN on a sensor device therefore reduces the power consumed during implementation and/or allows the implementation to be performed faster. This may allow an ANN to be implemented on a given sensor device (which may for example be resource constrained) which would not otherwise be possible. Additionally, or alternatively, the size of an ANN which may be implemented on a given sensor device may be increased. Counterintuitively the speed, power consumption and/or accuracy of data classification carried out on a sensor device may therefore be improved.

The stored integers representing the weights associated with interconnects between the nodes may have a bit length of thirty two bits or less.

The stored integers representing the weights associated with interconnects between the nodes may have a bit length of eight bits or less.

The stored integers representing the weights associated with interconnects between the nodes may have a bit length of more than two bits.

The stored integers may be static during implementation of the ANN.

The interconnects may be static during implementation of the ANN.

The stored integers may be determined based on weights computed by an external device on which the ANN is trained.

The interconnected nodes may comprise: an input layer of nodes; an output layer of nodes; and one or more hidden layers of nodes situated between the input layer of nodes and the output layer of nodes.

The ratio between: the bit length of the stored integers representing the weights associated with the interconnects; and the number of hidden layer nodes; may be 1:15 or less.

The bit lengths of the stored integers representing the weights associated with interconnects between the nodes may include a plurality of different bit lengths.

The stored integers may be ordered in the memory according to the bit length of the stored integers.

The sensor device may be a wearable device.

The sensor device may comprise communication means to transmit the determined classification of the data to an external device.

The sensor device may be an Internet-of-Things device.

According to a second aspect of the invention there is provided a training device comprising: a controller configured to carry out computations for implementing an artificial neural network “ANN” comprising a network of interconnect nodes; and memory coupled to the controller, to store weights associated with interconnects between the nodes; wherein the controller is operable to: receive training data comprising input data and known output data; optimise the ANN by iteratively adjusting the weights by comparing an output of the ANN with the known output data when the known input data is input to the ANN; and approximate the weights as integers.

The integers may have a bit length of thirty two bits or less.

The integers may have a bit length of eight bits or less.

The integers may have a bit length of more than two bits.

The bit lengths of the integers representing the weights associated with interconnects between the nodes may include a plurality of different bit lengths.

The training device may further comprise communication means to transmit the determined weights to a sensor device.

The controller may comprise a floating point unit “FPU”. The controller may be configured to cause the FPU to carry out the computations for implementing the ANN

According to a third aspect of the invention there is provided a method for classifying data on a sensor device comprising one or more sensors, the method comprising: measuring data using the one or more sensors; implementing an artificial neural network “ANN” on a controller comprising an arithmetic logic unit “ALU”, the ANN comprising a network of interconnected nodes, wherein the implementing comprises carrying out computations for implementing the ANN on the ALU; storing integers representing weights associated with interconnects between the nodes; and determining a classification of the data based on the network of interconnected nodes and weights associated with the interconnects.

The stored integers representing the weights associated with interconnects between the nodes may have a bit length of thirty two bits or less.

The stored integers representing the weights associated with interconnects between the nodes may have a bit length of eight bits or less.

The stored integers representing the weights associated with interconnects between the nodes may have a bit length of more than two bits.

The stored integers may be static during implementation of the ANN.

The interconnects may be static during implementation of the ANN.

The stored integers may be determined based on weights computed by an external device on which the ANN is trained.

The interconnected nodes may comprise: an input layer of nodes; an output layer of nodes; one or more hidden layers of nodes situated between the input layer of nodes and the output layer of nodes.

The ratio between the bit length of the stored integers representing the weights associated with the interconnects and the number of hidden-layer nodes may be 1:15 or less.

The bit lengths of the stored integers representing the weights associated with the interconnects between the nodes may include a plurality of different bit lengths.

Storing the integers representing the weights may comprise ordering the stored integers in memory according to the bit length of the stored integers.

The sensor device may be a wearable device.

The method may comprise transmitting the determined classification of the data to an external device.

The sensor device may be an Internet-of-Things device.

According to a fourth aspect of the invention there is provided a method for a training device, comprising: implementing an artificial neural network “ANN” comprising a network of interconnected nodes on a controller, wherein the controller carries out computations for implementing the ANN; storing weights associated with interconnects between the nodes; receiving training data comprising input data and known output data; optimising the ANN by iteratively adjusting the weights by comparing an output of the ANN with the known output data when the known input data is input to the ANN; and approximating the weights as integers.

The integers may have a bit length of thirty two bits or less.

The integers may have a bit length of eight bits or less.

The integers may have a bit length of more than two bits.

The bit lengths of the integers representing the weights associated with interconnects between the nodes may include a plurality of different bit lengths.

The method may further comprise transmitting the determined weights to a sensor device.

The controller may comprise a floating point unit “FPU”. The controller may cause the FPU to carry out the computations for implementing the ANN.

According to a fifth aspect of the invention there is provided computer software which, when executed by a computer, is arranged to perform a method according to the third aspect and/or the fourth aspect. The computer software may be stored on a computer readable medium. The computer readable medium may be non-transitory.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

The present invention will now be described, by way of example only, with reference to the accompanying drawings, in which:

FIG. 1A illustrates a system for classifying data;

FIG. 1B is a block diagram view of a sensor device in accordance with an embodiment of the present invention;

FIG. 1C is a block diagram view of a training device in accordance with an embodiment of the present invention;

FIG. 2 is a block diagram view of an artificial neural network in accordance with an embodiment of the present invention;

FIGS. 3A-3E are schematic representations of results used to illustrate advantages of the present invention;

FIGS. 4A-4E are schematic representations of results used to illustrate advantages of the present invention when employed on a large data set;

FIG. 5 is a process flow diagram of a method for classifying data on a sensor device in accordance with an embodiment of the present invention; and

FIG. 6 is a process flow diagram of a method for training an artificial neural network in accordance with an embodiment of the present invention.

### DETAILED DESCRIPTION OF THE DRAWINGS

Before particular examples of the present invention are described, it is to be understood that the present disclosure is not limited to the particular embodiments described herein. It is also to be understood that the terminology used herein is used for describing particular examples only and is not intended to limit the scope of the claims.

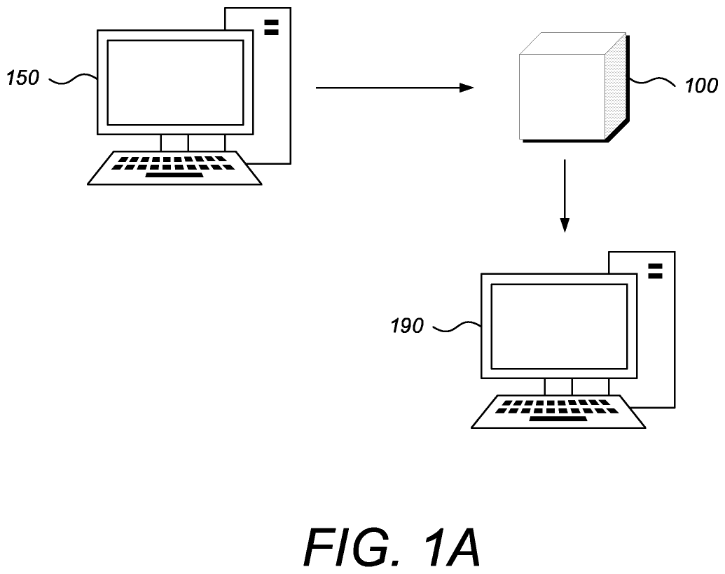

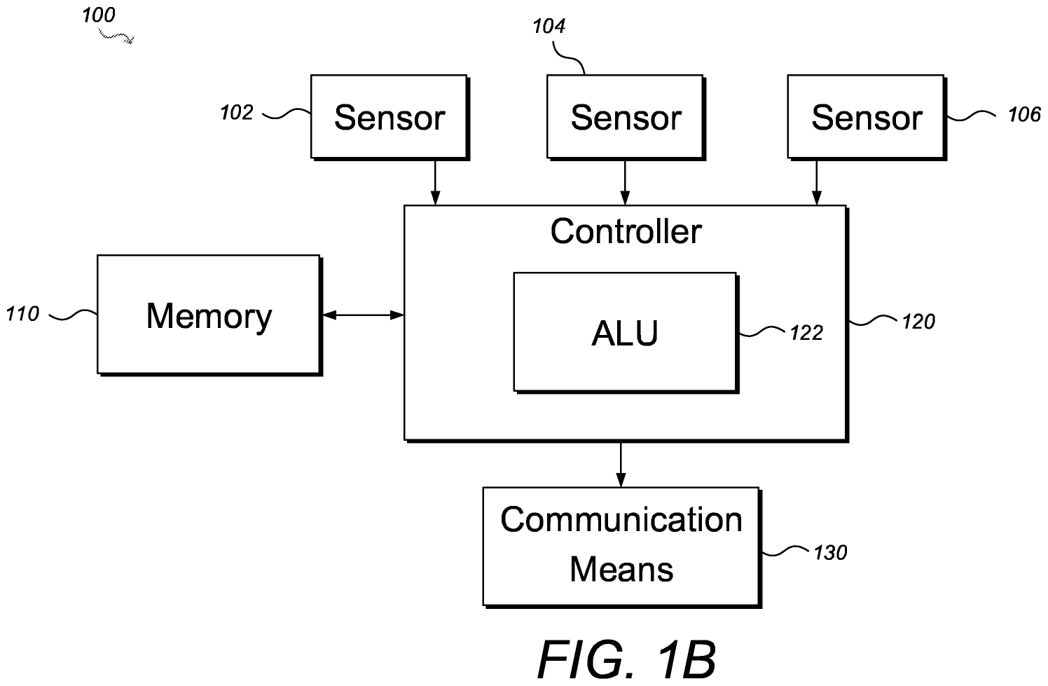

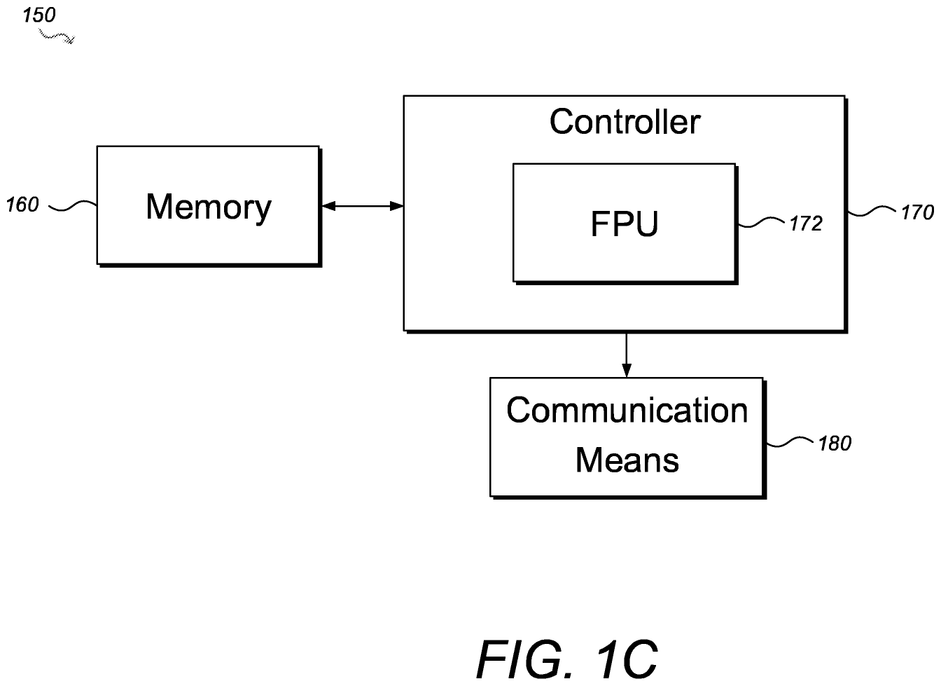

FIG. 1A illustrates a system for classifying data according to an embodiment of the invention. The system comprises a sensor device 100, a training device 150 and an external device 190. Whilst in the embodiment of FIG. 1A, the training device 150 and the external device 190 are represented as separate devices, in some embodiments a single device may realise the function of both the training device 150 and the external device 190. The training device 150 and/or the external device 190 may be any suitable electronic device such as, for example, a desktop computer, a laptop computer, a workstation, a mobile telephone, a smartphone and/or a tablet device. In general, the training device 150, and the external device 190 each comprise at least a processor and memory coupled to the processor.

The sensor device 100 comprises one or more sensors for measuring data and is configured to classify sensor data using an artificial neural network (ANN) implemented on the sensor device 100. As will be explained in further detail below, the artificial neural network which is implemented on the sensor device 100 is based on an artificial neural network trained by the training device 150. The classified data (i.e. the classifications of sensor data determined by the sensor device 100) may be sent to an external device 190. The external device 190 may store the classified data and/or may present it for a user to view (e.g. on an electronic display). In addition to, or alternatively the classified data may be stored and/or displayed on the sensor device 100.

In general, training an artificial neural network requires more resources in terms of memory, CPU and power than implementing an ANN to classify data. The training device 190 may therefore be a device having access to more resources than, for example, the sensor device 100. For example, the training device 150 may not be limited by at least power (e.g. the training device may have substantial power resources and/or may be connected to a mains power source). The training device 150 may, for example, comprise a desktop computer, a laptop computer, a workstation, a tablet device, a smartphone device and/or any other device having access to substantially more resources (e.g. processing power, memory and/or power resources) than the sensor device 100.

In general, implementing an artificial neural network in order to classify data requires substantially less resources than training an artificial neural network. One or more properties determined during training of the ANN on the training device 150 may be transferred to the sensor device 100, which implements an ANN (based on the one or more properties determined during training of the ANN on the training device 150) in order to classify data measured by the sensor device 100.

FIG. 1B illustrates an embodiment of the sensor device 100 in further detail. The sensor device 100 comprises a controller 120, which comprises at least an arithmetic logic unit (ALU) 122. The ALU is configured to perform arithmetic and logic operations on binary integers. In some embodiments, the controller 120 may comprise a processor such as a microprocessor. In some embodiments, the controller 120 may comprise one or more further components such as a floating-point unit, one or more registers and/or cache memory.

In the embodiment shown in FIG. 1B, the controller 120 is coupled to a first sensor 102, a second sensor 104, a third sensor 106, memory 110 and communication means 130.

Each of the first sensor 102, the second sensor 104 and the third sensor 106 is configured to carry out measurements and produce measurement data based on the measurements. A sensor 102, 104, 106 may measure one or more properties over time. The measurement data produced by a sensor 102, 104, 106 may, for example, comprise one or more time series representing one or more measured properties over time.

By way of example, one or more of the first 102, second 104 and/or third 106 sensors may perform measurements which are indicative of one or more properties such as (but not limited to) acceleration, temperature, pressure, orientation, rotation, noise intensity, location and/or light intensity. Whilst the sensor device 100 depicted in FIG. 1B comprises three sensors 102, 104, 106, in other embodiments a sensor device 100 may include any number of sensors, including only one.

The memory 110 is configured to store measurement data produced by the sensors 102, 104, 106. The memory may comprise volatile and/or non-volatile memory. In some embodiments, the memory 110 may comprise both volatile and non-volatile memory.

The controller 120 is operable to implement an artificial neural network for classifying data measured by the sensors 102, 104, 106. In particular, the controller is configured to cause the ALU to carry out computations (e.g. calculations such as arithmetic operations) to implement an ANN. That is, arithmetic operations needed to implement the ANN may be carried out on the ALU in the sensor device 100. Implementation of the artificial neural network to classify measurement data will be described in further detail below.

The communication means 130 may be configured to transmit the classified data to the external device 190. The communication means 130 may, for example, be operable to transmit data wirelessly. For example, the communication means 130 may be operable to transmit data using one or more of GSM, Wi-Fi, Bluetooth or LTE communication protocols. Additionally or alternatively the communication means 130 may be operable to transmit and/or receive data through a wired connection.

Whilst, the embodiment of a sensor device 100 which is shown in FIG. 1B comprises a communication means 130, in some embodiments the sensor device 100 may not include a communication means 130. Additionally or alternatively, a sensor device 100 may include one or more further components not shown in FIG. 1B. For example, a sensor device 100 may comprise one or more of an electronic display and/or a sound output device (e.g. a speaker). An electronic display may, for example, be arranged to display a representation of a classification of measurement data as determined by the artificial neural network implemented on the controller 120. A sound output device may be arranged to output a sound indicative of a classification of measurement data as determined by the artificial neural network.

FIG. 10 illustrates a training device 150 according to an embodiment of the invention. The training device 150 comprises a controller 170, a communication means 180 and memory 160. In the embodiment of FIG. 10, the controller 170 comprises at least a floating-point unit (FPU) 172. The FPU 172 is configured to perform arithmetic operations on floating point numbers. The controller 170 is coupled to a communication means 180.

The memory 160 is configured to store training data. The training data comprises a set of known input data and known output data. The known input data is indicative of measured sensor data and the known output data is indicative of known classifications based on the measured sensor data. The memory 160 may comprise volatile and/or non-volatile memory. In some embodiments, the memory 160 may comprise both volatile and non-volatile memory.

In some embodiments, the controller 170 may comprise a processor such as a microprocessor. In some embodiments, the controller 120 may comprise one or more further components such as an arithmetic logic unit (ALU), one or more registers and/or cache memory.

The controller 170 is operable to implement an artificial neural network for classifying data based on the input data. In particular, the controller may be configured to cause the FPU to carry out computations (e.g. calculations such as arithmetic operations) to implement an ANN. That is, arithmetic operations needed to implement the ANN may be carried out on the FPU 172 in the training device 150. In alternative embodiments the controller may be configured to cause an ALU (not shown in FIG. 10) to carry out at least some computations for implementing an ANN on the training device 150.

FIG. 2 illustrates a block diagram of an example of an artificial neural network (ANN) 200. The ANN 200 may, for example, be operably implemented by carrying out computations (e.g. arithmetic operations) on the ALU 122 of the sensor device 100 or, for example, the FPU 172 of the training device 150.

The ANN comprises an input layer of nodes 201, a hidden layer of nodes 203, and an output layer of nodes 207. Each node has at least one value associated with it. The values associated with each node 201a-c, 203d-g, 207l-m may, for example, be stored in memory coupled to a controller 120, 170 on which the ANN is implemented. The values may, for example, be stored in non-volatile memory and accessed by a controller 120, 170 on which the ANN is implemented. Additionally or alternatively, the values associated with each node 201a-c, 203d-g, 207l-m may be stored in cache memory which forms part of a controller 120, 170.

The input layer of nodes 201 is coupled to the hidden layer of nodes 203 via interconnects 202. The hidden layer of nodes 203 is coupled to the output layer of nodes 207 via interconnects 206. Each interconnect has an associated weight value. The weight values associated with interconnects 202, 206 may, for example, be stored in memory coupled to a controller 120, 170 on which the ANN is implemented. The weight values may, for example, be stored in volatile or non-volatile memory and accessed by a controller 120, 170 on which the ANN is implemented. Additionally or alternatively the values associated with each node 201a-c, 203d-g, 207l-m may be stored in cache memory which forms part of a controller 120, 170.

In use, the values at each of the hidden layer nodes 203 are calculated by multiplying the weight values associated with each interconnect 202 by the values of each respective input layer node 201. The values of each respective input layer node 201 may be set according to input data. The input data may, for example, comprise measurement data. In some embodiments, the input data may comprise a plurality of values, which may, for example, represent a time series of measured data.

By way of example, a value associated with the first hidden layer node ‘d’ is calculated by:

203d=201a×202ad+201b×202bd+201c×202cd (1)

Similarly, a value associated with the output layer node ‘1’ is calculated by:

207l=203d×206dl+203e×206el+203f×206fl+203g×206gl (2)

It will be understood that similar calculations are performed to calculate the values of nodes 203e-g and 207m.

Optionally, at each node an activation function is performed on the calculated value to transform it into an output signal. Activation functions are generally used to model complex non-linear patterns. Example activation functions include, but are not limited to: linear, sigmoid, hyperbolic tangent and stepwise.

Computed values of the output layer of nodes 207 forms output data of the ANN. The output data may, for example, be indicative of a classification of the measurement data which is provided as an input to the ANN. For example, each output node 207l,m of the ANN may correspond to a given classification and the computed value of an output node may be indicative of whether the measurement data matches the classification associated with the output node.

By way of example only, in an embodiment in which the sensor device 100 comprises a wearable activity tracker the output nodes may be associated with different activity types. For example, the output node 207l may be associated with a classification that the user is performing press-ups and the output node 207m may be associated with a classification that the user is performing sit-ups. For a given set of measurement data provided as an input to the ANN, the computed values associated with the output nodes 207l,m may indicate whether the user is doing sit-ups, doing press-ups or doing neither sit-ups or press-ups. In other embodiments additional or alternative activity types may be contemplated and output nodes associated with additional or alternative activity types may be provided.

In the embodiment illustrated in FIG. 2, each node is connected to every node in the subsequent layer. However, such an arrangement is not essential, and in some embodiments one or more nodes may not be connected to each node in a subsequent and/or previous layer. That is, one or more of the interconnects 202as-ag, 206dl-nm need not necessarily be present in the embodiment shown in FIG. 2.

Furthermore, it will be understood that whilst the embodiment of FIG. 2 illustrates a single hidden layer, any number of hidden layers may be used. For example, in some embodiments an ANN may comprise a plurality of hidden layers joined together by respective weighted interconnects. Furthermore, each individual layer may comprise any number of nodes, including only one.

When the ANN 200 is implemented on the sensor device 100 by the controller 120 the input layer nodes 201 are coupled to the sensors 102, 104, 106 of the sensor device 100. That is, the values associated with the input layer nodes 201 are set according to measurement data output by the sensors 102, 104, 106. Each sensor 102, 104, 106 might, for example, be coupled to a different input node 201a-c of the input layer 201.

In some embodiments, measurement data may be buffered and/or aggregated prior to being provided as an input to the ANN 200. In such embodiments, values associated with input nodes of the ANN may be set according to buffered and/or aggregated measurement data. For example, measurement data may be buffered, aggregated and then provided as an input to the ANN for classification.

In the sensor device 100, the ALU 122 is used to perform the calculations for classifying the data. That is, the arithmetic used to calculate values at each of nodes in the ANN (as was described above with reference to equations 1 and 2) is carried out by the ALU in the sensor device 100.

When the ANN 200 is implemented on the training device 150 by the controller 170, the input layer nodes 201 are coupled to input data of a predetermined training data set. The training data set may, for example, include input data comprising measurement data collected in situations where the classification of the measurement data is known and output data comprising the known classification of the measurement data. For example, in an embodiment in which the sensor device comprises a wearable activity monitoring device, a training data set may include input data comprising measurement data collected whilst a user is performing a known activity type and output data comprising the known activity type.

The ANN 200 may be trained according to a plurality of training data sets by iteratively updating the weights associated with interconnects in the ANN. The weights are updated in order to improve the accuracy of data classification based on the training data sets. This may be achieved by comparing the outputs of the ANN, when training data set input data is input to the ANN, to the corresponding output data of the training data sets. In some embodiments, as part of the training process, one or more interconnects between nodes may be removed. For example, if after training of the ANN, an interconnect has a low weight associated with it, then the contribution of the interconnect to the computed values of the output nodes 207 will also be low. In such a situation, the interconnect may be removed from the ANN so as reduce the computational burden of implementing the ANN. Removing one or more interconnects from an ANN may additionally or alternatively reduce an amount of memory which is used by the ANN. That is, the memory footprint of the ANN may be reduced by removing one or more interconnects from an ANN.

In the training device 150, the FPU 122 may be used to perform the calculations needed to classify the data. That is, the arithmetic for calculating values at each of the nodes in the ANN (as was described above with reference to equations 1 and 2) may be carried out by the FPU in the training device 150. Whilst embodiments are described herein in which an FPU 122 on a training device 150 carries out computations for implementing an ANN, in alternative embodiments, at least some of the computations may be carried out by an ALU which forms part of the training device 150.

In embodiments in which the FPU 122 is used to carry out computations for implementing the ANN, the weights associated with interconnects of the ANN may be represented and stored as floating-point numbers. The weights may, for example, be stored in the memory 160. Once the training process has been completed, the optimised weights may be transmitted to the sensor device 100, for example, through communication between the communication means 180 of the training device and the communication means 130 of the sensor device 100. The weights which are received by the sensor device 100 may, for example, be stored in the memory 110 of the sensor device 100. The controller 120 of the sensor device 100 then implements the ANN on the sensor device 100 to classify measurement data output by the sensors 102, 104, 106 using the weights output from the training process carried out on the training device 150.

The weights may be approximated as integers by the training device 150. For example, the controller 170 may convert the weights (which may be stored as floating point numbers) to integers, before the weights are transmitted to the sensor device 100.

The weights which are stored and used on the sensor device 100 may be static during implementation of the ANN on the sensor device 100. That is, the sensor device 100 may not itself compute any updates to the weights. In at least some embodiments the weights stored on the sensor device 100 are static, in that the sensor device does not itself compute any updates to the weights. The weights which are stored and used on the sensor device 100 may only be updated if new weights are communicated to the sensor device 100, for example, from the training device 150.

Additionally or alternatively, the interconnects which are stored and used on the sensor device 100 may be static during implementation of the ANN on the sensor device 100. That is, the sensor device 100 may not itself compute any updates to the interconnects. The interconnects which are stored and used on the sensor device 100 may only be updated if new interconnect information is communicated to the sensor device 100, for example, from the training device 150.

In general, training an artificial neural network is a more resource intensive process (e.g. requires more power, more memory and/or more processing power) than implementing a trained ANN in order to classify measurement data. By training the ANN on a training device 150 which is independent of the sensor device 100, the use of resources on the sensor device 100 is reduced (when compared to training an ANN on the sensor device 100). A sensor device 100 having a given set of resources is therefore able to implement a larger and/or more complex ANN when the ANN is trained on a separate training device 150, since the resources of the sensor device 100 are not used to train the ANN. Furthermore, by using static weights on the sensor device 100 (i.e. the sensor device 100 does not itself compute any updates to the weights) then the computations which are carried out on the sensor device 100 are reduced.

As was explained above, on the sensor device 100 an ALU 122 is used to carry out the computations needed to implement the ANN, whereas on the training device 150 a FPU 172 may be used to carry out the computations.

In general, an ALU is more energy efficient than an FPU. That is, a given arithmetic operation can be carried out on an ALU using less power than carrying out a corresponding arithmetic operation on an FPU. By using an ALU 122 to carry out the computations needed to implement an ANN on the sensor device 100, the power required to implement the ANN is therefore significantly reduced (e.g. when compared to carrying out the computations on an FPU). Additionally, using an ALU to carry out the computations needed to implement an ANN may improve the speed with which the computations are carried out. For example, using an ALU to carry out the computations may allow measurement data to be classified up to four times faster (when compared to using an FPU).

The above noted improvement in energy efficiency and computational speed from using an ALU advantageously allows an ANN to be implemented to classify data on a resource restricted device such as a sensor device 100, which may, for example, have a limited power source (such as a battery) and/or may have limited processing and/or memory resources.

Using an ALU 122 to carry out the computations for implementing an ANN on the sensor device 100, means that the computations are carried out using integers as opposed to floating point values. Accordingly, the weights associated with the interconnects 202ad-ag, 206dl-gm may be stored as integers (e.g. in the memory 110). In some embodiments, other values used in the implementation of an ANN in order to classify measurement data may also be stored as integers. For example, measurement data output by the sensors 102-106 and used as input data to the ANN may be represented and stored as integers. Additionally or alternatively values associated with nodes in the ANN (e.g. nodes in the hidden layer 203) may be represented and stored as integers.

Representing and storing values used in the implementation of an ANN as integers, reduces the memory footprint of the ANN (when compared to representing and storing the values as floating point values). This may allow an ANN to be implemented on a memory constrained device. For example, a typical sensor device 100 may have a memory capacity of the order of only about 2.4 kilobytes. In such a memory constrained device, the use of integers to represent values used in the implementation of an ANN may allow an ANN to be implemented, which a sensor device 100 would otherwise be unable to implement using a floating point representation.

Additionally or alternatively, representing and storing values as integers may allow the size of an ANN which can be implemented on a given sensor device 100 to be increased. That is, the number of nodes which form an ANN implemented on the sensor device 100 may be increased. As will be explained in further detail below, increasing the number of nodes which form an ANN may improve the accuracy of a given classification which is carried out by the ANN.

It might be assumed that using an ALU to carry out computations for implementing an ANN to classify measurement data, would reduce the accuracy of the classification since only integer arithmetic can be carried out on the ALU. However, somewhat counterintuitively, it has been found that by representing and storing values as integers and carrying out arithmetic operations on an ALU, the classification accuracy which is possible on a given resource limited sensor device 100 can be improved, since a larger ANN can be used.

The size of an ANN which can be implemented on a given resource limited sensor device 100 may be further increased by reducing the bit length of at least some of the values used to implement the ANN. For example, the bit length of the weights associated with interconnects in the ANN may be reduced. It will be appreciated that by reducing the bit length of values used to implement an ANN, the memory footprint of the ANN is reduced. For a given available memory on a sensor device 100, the size (i.e. the number of nodes) of an ANN which can be implemented on the sensor device 100 may therefore be increased by reducing the bit length of at least some of the values used to implement the ANN. Counterintuitively, reducing the bit length of at least some of the values used to implement the ANN can therefore increase the accuracy of a classification which is possible on a given resource limited sensor device 100.

In some embodiments, the weights stored on the sensor device 100 may have a bit length of thirty two bits or less. For example, the weights stored on the sensor device 100 may have a bit length of eight bits or less. By way of example, by reducing the bit length of the weights from say sixteen bits to eight bits, an ANN having approximately twice as many neurons and/or twice as many interconnects between neurons may be stored and implemented on a sensor device 100 having a given set of resources.

In some embodiments, the weights stored on the sensor device 100 may have a bit length of four bits. In some embodiments, the weights stored on the sensor device 100 may have a bit length of four bits or more. In some embodiments, the weights stored on the sensor device 100 may have a bit length of more than two bits

As was explained above, whilst an ANN is implemented on a sensor device 100 using an integer representation and by carrying out arithmetic computations on an ALU 122, the ANN may be implemented and trained on the training device 150 using a floating point representation and by carrying out arithmetic computations on an FPU 172. As was also explained above, typically the training device 150 is not as resource constrained as the sensor device 100. Accordingly, the training device 150 may have sufficient resources in order to implement and train an ANN using a floating point representation. Using a floating point representation on the training device 150 may improve the accuracy with which the ANN is trained.

One or more properties of the ANN which is trained on the training device 150 may be communicated to the sensor device 100 in order for the sensor device to implement the trained ANN. For example, interconnects and their associated weights determined during the training process may be communicated to the sensor device 100. The training device 150 may convert the one or more properties to be communicated to the training device 150 to an integer representation suitable for storage and implementation on the sensor device 100. For example, the training device 150 may convert weights determined during the training process to integers of a given bit length. The bit length may, for example be thirty two bits or less and in some embodiments may be eight bits or less. The bit length may, for example, be greater than two bits. In some embodiments, the training device may determine one or more bit lengths to be used according to a given application and/or sensor device to be used.

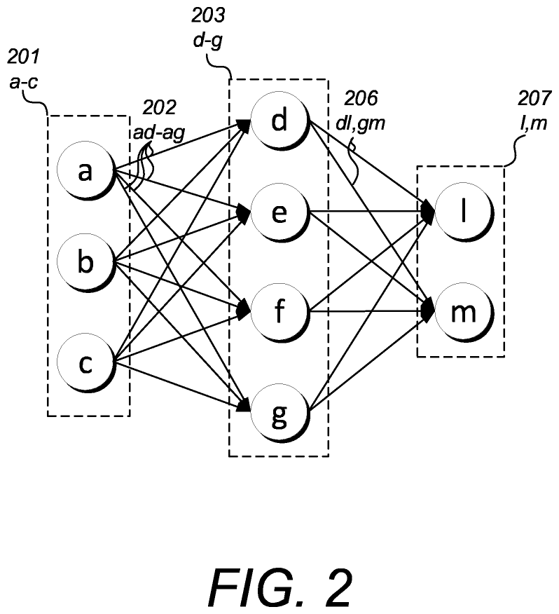

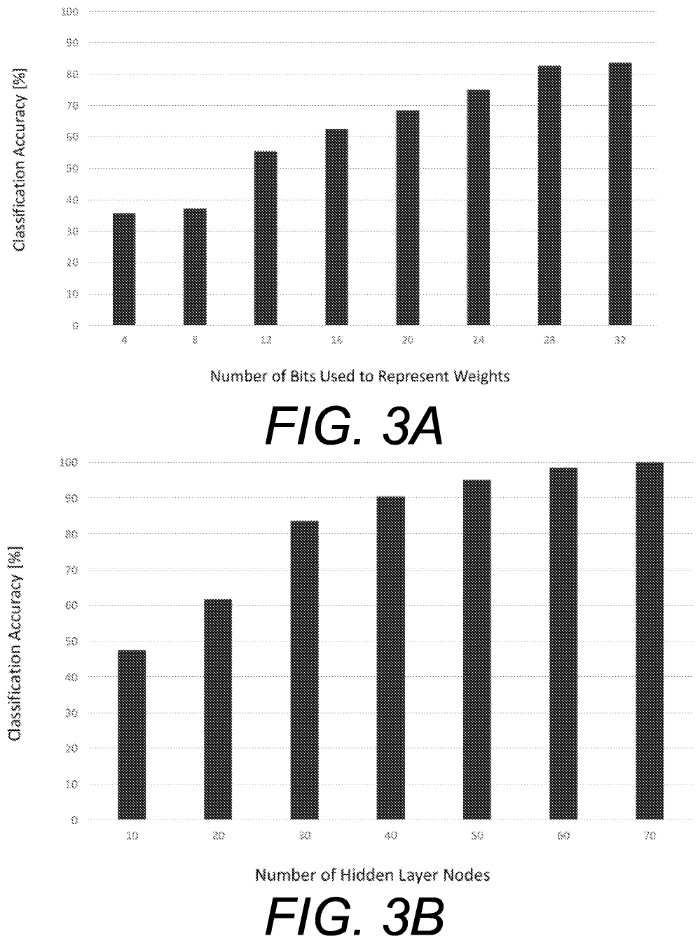

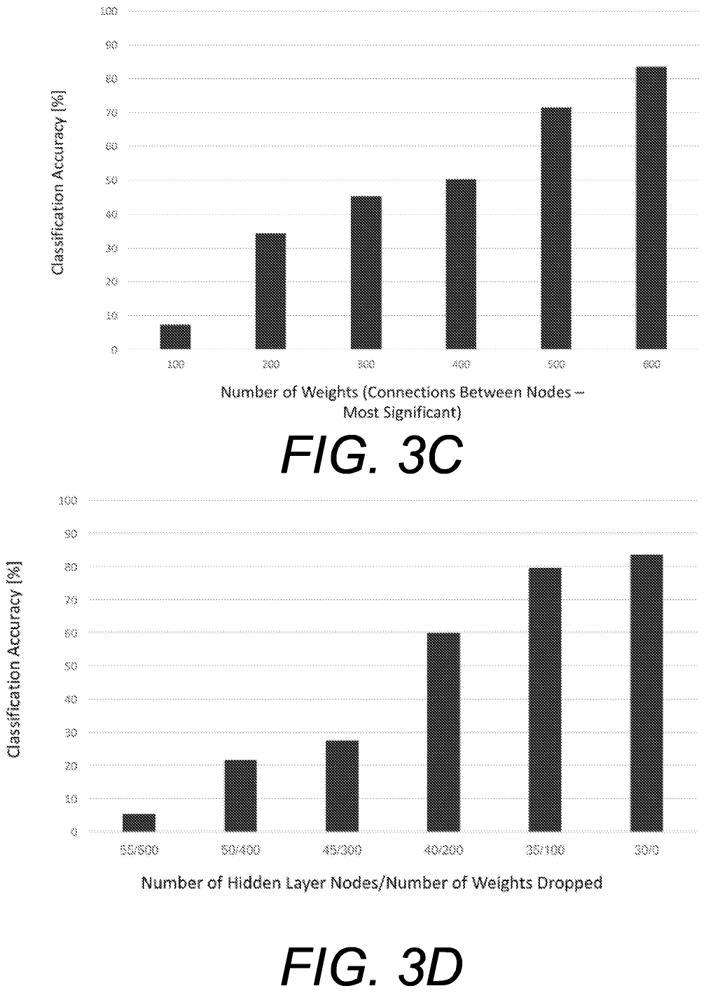

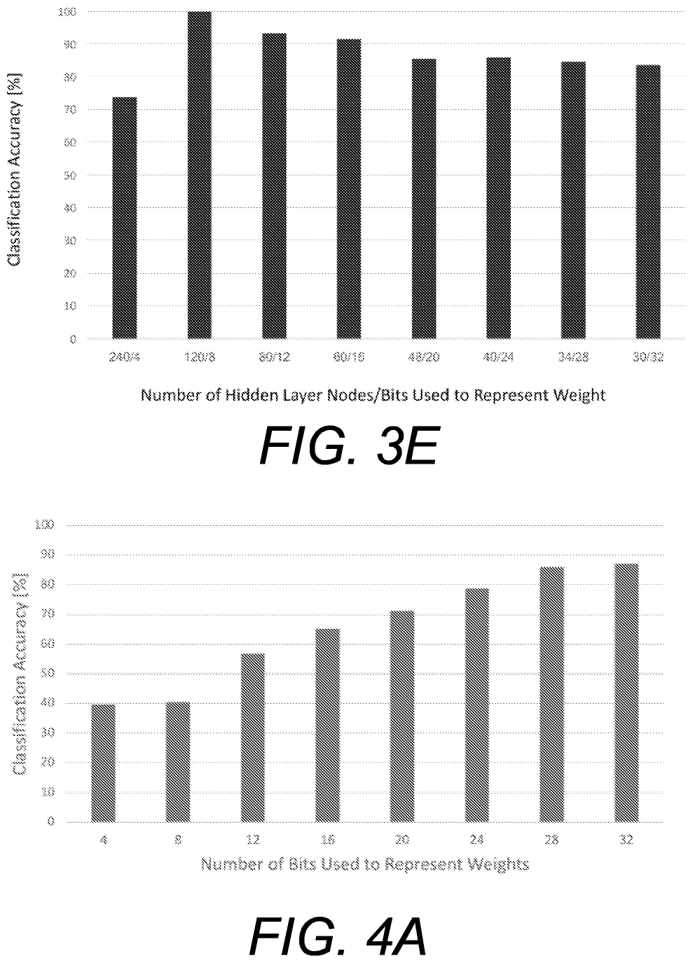

Various advantages of the invention have been explained above. In order to further illustrate advantages associated with the present invention the results of a number of experiments will be described below with reference to FIGS. 3A-3E. Each of FIGS. 3A-3E represent results which were acquired by implementing an ANN having 15 input nodes and 5 output nodes. An input data set having known classifications is used. Eighty percent of the data was used to train the ANN and the remaining twenty percent of the data set was input to the trained ANN for classification. The classification accuracies which are represented in FIGS. 3A-3E correspond to the percentage of data input to the trained ANN which was correctly classified by the ANN.

FIG. 3A is a schematic representation of the classification accuracy of an ANN at a number of different bit lengths used to represent weights associated with interconnects of the ANN. The results shown in FIG. 3A were acquired using an ANN having a single hidden layer comprising 30 nodes. Each hidden layer node is connected to each input layer node and each output layer node. The memory footprint of the ANN is approximately 2.4 kilobytes which may be typical of the type of memory budget, which is available on a sensor device 100. A number of different experiments were performed using different bit lengths to represent the weights of the ANN ranging from 4-32 bits.

As might be expected and as can be seen from FIG. 3A, decreasing the bit length used to represent the weights has the effect of decreasing the classification accuracy. For example, the classification accuracy decreases from approximately 83% using a 32 bit representation to approximately 35% using a 4 bit representation. It might therefore be assumed that increasing the bit length of the representation will always improve the classification accuracy.

FIG. 3B is a schematic representation of the classification accuracy of ANNs having different numbers of nodes in the hidden layer. The results shown in FIG. 3B were generated using a 32 bit representation of the weights in the ANN. The number of nodes in the hidden layer ranges from 10 to 70. It can be seen from FIG. 3B that the classification accuracy increases by increasing the number of hidden layer nodes. For example, the classification accuracy increases from about 47% using 10 hidden layer nodes to about 99% using 70 hidden layer nodes. However, using 70 hidden layer nodes at a bit length of 32 bits results in an ANN having a memory footprint which exceeds 2.4 kilobytes. The memory footprint of the ANN may therefore exceed a memory budget which might typically be available on a sensor device 100.

FIG. 3C is a schematic representation of the classification accuracy of ANNs having different numbers of weights (i.e. the number of interconnects represented by weights) used to represent interconnections between nodes in the ANNs. The results shown in FIG. 3C were generated using a 32 bit representation of the weights in the ANN and using an ANN having 30 hidden layer nodes. Starting from a maximum number of 600 weights as shown at the right-hand side of FIG. 3C, the number of weights used is dropped by removing the smallest weights from the ANN. As can be seen in FIG. 3C, even when the smallest weights are removed first, the classification accuracy decreases fairly quickly as the number of weights is reduced. Reducing the number of weights used in an ANN may therefore only provide fairly limited memory savings before the classification accuracy is significantly reduced.

FIG. 3D is a schematic representation of the classification accuracy of ANNs having different numbers of hidden layer nodes and weights (i.e. interconnects represented by weights). The results shown in FIG. 3D were generated using a 32 bit representation of the weights in the ANN. FIG. 3D represents a situation where a limited memory budget of 2.4 kilobytes is available and the number of hidden layer nodes and weights is adjusted whilst keeping the memory footprint of the ANN at about 2.4 kilobytes or less. The left-hand number below each bar shown in FIG. 3D represents the number of hidden layer nodes being used in the ANN. The right-hand number below each bar shown in FIG. 3D represents the number of weights which are removed from the ANN, where the smallest weights are the first to be removed. Moving from the right-hand side to the left-hand side of FIG. 3D, removing weights from the ANN frees up memory which allows the number of hidden layer nodes to be increased.

As can be seen in FIG. 3D, even when the number of hidden layer nodes is increased as the number of weights is reduced, the classification accuracy decreases fairly quickly as the number of weights is reduced. Little or no improvement in the classification accuracy is therefore achieved by reducing the number of weights (dropping the least significant weights first) to allow more hidden layer nodes to be used on a resource constrained sensor device.

FIG. 3E is a schematic representation of the classification accuracy of ANNs having different numbers of hidden layer nodes and using representations of weights having different numbers of bit lengths. Similarly to FIG. 3D, FIG. 3E represents a situation where a limited memory budget of 2.4 kilobytes is available and the number of hidden layer nodes and weights is adjusted whilst keeping the memory footprint of the ANN at about 2.4 kilobytes or less. The left-hand number below each bar shown in FIG. 3E represents the number of hidden layer nodes being used in the ANN. The right-hand number below each bar shown in FIG. 3E represents the number of bits used to represent the weights in the ANN.

Moving from the right-hand side to the left-hand side of FIG. 3E, the number of bits used to represent the weights is reduced. As was explained above with reference to FIG. 3A, typically, reducing the bit length used to represent weights in an ANN serves to decrease the classification accuracy achieved by the ANN. However somewhat counterintuitively, reducing the bit length used to represent the weights can serve to increase the classification accuracy on a resource constrained device since, as can be seen in FIG. 3E, reducing the bit length frees up memory which can be used to increase the number of nodes in the ANN. In the example shown in FIG. 3E, reducing the bit length and increasing the number of hidden layer nodes serves to increase the classification accuracy down to a bit length of eight bits. In the example shown in FIG. 3E, reducing the bit length further to four bits serves to decrease the classification accuracy even though more hidden layer nodes are added.

As has been explained above with reference to FIGS. 3A-3E using an integer representation to implement an ANN carrying out arithmetic on an ALU advantageously, and counterintuitively increases the accuracy with which measurement data can be classified on a resource constrained sensor device. Furthermore, reducing the bit length of the integer representation (for example, to a bit length of 8 bits or less) can increase the classification accuracy by allowing the size (i.e. the number of nodes) of the ANN to be increased.

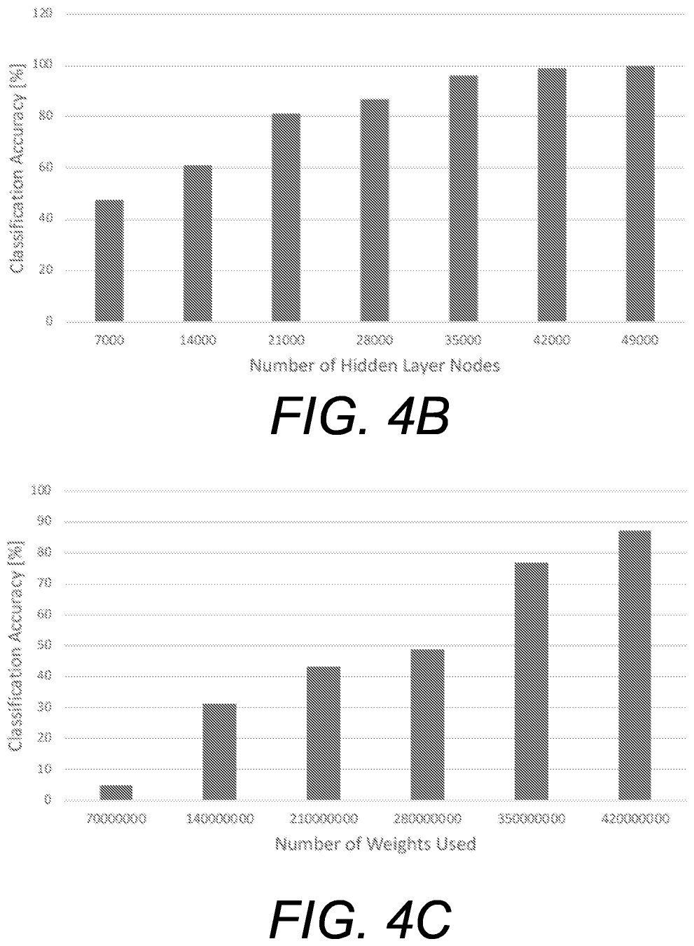

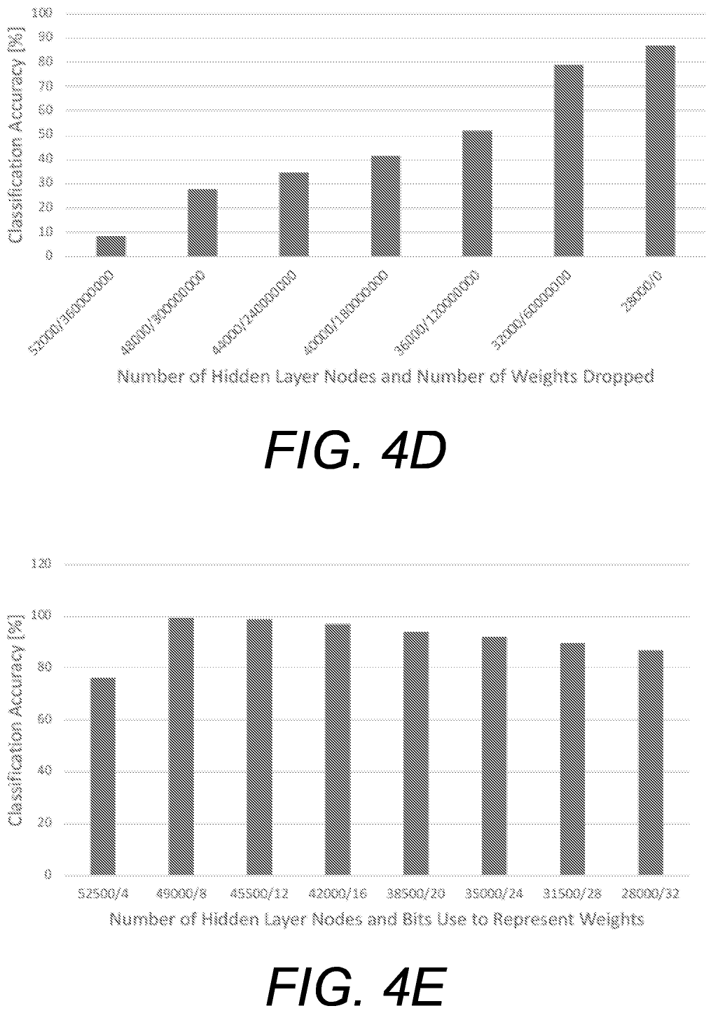

Embodiments have been described above in which a relatively small ANN (e.g. having a relatively small number of nodes) having a relatively small memory footprint is implemented in order to classify data. However, the features, examples and embodiments described herein may also provide advantages when implementing a larger ANN (e.g. having more nodes) which has a larger memory footprint and which may be used to classify a larger dataset. In order to illustrate advantages associated with the present invention when using classifying a larger dataset using a larger ANN the results of a number of further experiments will be described below with reference to FIGS. 4A-4E.

Each of FIGS. 4A-4E represent results which were acquired by implementing an ANN having 14,000 input nodes and 1,000 output nodes. An input data set having known classifications is used. Eighty percent of the data was used to train the ANN and the remaining twenty percent of the data set was input to the trained ANN for classification. The classification accuracies which are represented in FIGS. 4A-4E correspond to the percentage of data input to the trained ANN which was correctly classified by the ANN.

In the examples illustrated in FIGS. 4A-4E, the input data comprises a number of images which are classified. Image data represents a more complex data set than the physical exercise data described above and is therefore more suited to classification using a large ANN.

FIG. 4A is a schematic representation of the classification accuracy of an ANN at a number of different bit lengths used to represent weights associated with interconnects of the ANN. The results shown in FIG. 4A were acquired using an ANN comprising 28,000 nodes hidden layer nodes. The memory footprint of the ANN is approximately 1.6 gigabytes which represents a larger memory budget than was described above with reference to FIGS. 3A-3E. A number of different experiments were performed using different bit lengths to represent the weights of the ANN ranging from 4-32 bits.

As might be expected and as can be seen from FIG. 4A, decreasing the bit length used to represent the weights has the effect of decreasing the classification accuracy. For example, the classification accuracy decreases from just under 90% using a 32 bit representation to approximately 40% using a 4 bit representation. As was explained above with reference to FIGS. 3A-3E, it might therefore be assumed that increasing the bit length of the representation will always improve the classification accuracy.

FIG. 4B is a schematic representation of the classification accuracy of ANNs having different numbers of nodes in the hidden layer. The results shown in FIG. 4B were generated using a 32 bit representation of the weights in the ANN. The number of nodes in the hidden layer ranges from 7000 to 49,000. It can be seen from FIG. 4B that the classification accuracy increases by increasing the number of hidden layer nodes. For example, the classification accuracy increases from about 47% using 7000 hidden layer nodes to close to 100% using 49,000 hidden layer nodes. However, using 49,000 hidden layer nodes at a bit length of 32 bits results in an ANN having a memory footprint which exceeds 1.6 gigabytes. The memory footprint of the ANN may therefore exceed a memory budget which might be available for classification of the data.

FIG. 4C is a schematic representation of the classification accuracy of ANNs having different numbers of weights (i.e. the number of interconnects represented by weights) used to represent interconnections between nodes in the ANNs. The results shown in FIG. 4C were generated using a 32 bit representation of the weights in the ANN and using an ANN having 28,000 hidden layer nodes. Starting from a maximum number of 420,000,000 weights as shown at the right-hand side of FIG. 4C, the number of weights used is dropped by removing the smallest weights from the ANN. As can be seen in FIG. 4C, even when the smallest weights are removed first, the classification accuracy decreases fairly quickly as the number of weights is reduced. Reducing the number of weights used in an ANN may therefore only provide fairly limited memory savings before the classification accuracy is significantly reduced.

FIG. 4D is a schematic representation of the classification accuracy of ANNs having different numbers of hidden layer nodes and weights (i.e. interconnects represented by weights). The results shown in FIG. 4D were generated using a 32 bit representation of the weights in the ANN. FIG. 3D represents a situation where a memory budget of 1.6 gigabytes is available and the number of hidden layer nodes and weights is adjusted whilst keeping the memory footprint of the ANN at about 1.6 gigabytes or less. The left-hand number below each bar shown in FIG. 4D represents the number of hidden layer nodes being used in the ANN. The right-hand number below each bar shown in FIG. 4D represents the number of weights which are removed from the ANN, where the smallest weights are the first to be removed. Moving from the right-hand side to the left-hand side of FIG. 4D, removing weights from the ANN frees up memory which allows the number of hidden layer nodes to be increased.

As can be seen in FIG. 4D, even when the number of hidden layer nodes is increased as the number of weights is reduced, the classification accuracy decreases fairly quickly as the number of weights is reduced. Little or no improvement in the classification accuracy is therefore achieved by reducing the number of weights (dropping the least significant weights first) to allow more hidden layer nodes to be used on a resource constrained sensor device.

FIG. 4E is a schematic representation of the classification accuracy of ANNs having different numbers of hidden layer nodes and using representations of weights having different numbers of bit lengths. Similarly to FIG. 4D, FIG. 4E represents a situation where a memory budget of 1.6 gigabytes is available and the number of hidden layer nodes and weights is adjusted whilst keeping the memory footprint of the ANN at about 1.6 gigabytes or less. The left-hand number below each bar shown in FIG. 4E represents the number of hidden layer nodes being used in the ANN. The right-hand number below each bar shown in FIG. 4E represents the number of bits used to represent the weights in the ANN.

Moving from the right-hand side to the left-hand side of FIG. 4E, the number of bits used to represent the weights is reduced. As was explained above with reference to FIGS. 3A and 4A, typically, reducing the bit length used to represent weights in an ANN serves to decrease the classification accuracy achieved by the ANN. However somewhat counterintuitively, reducing the bit length used to represent the weights can serve to increase the classification accuracy on a resource constrained device since, as can be seen in FIG. 4E, reducing the bit length frees up memory which can be used to increase the number of nodes in the ANN. In the example shown in FIG. 4E, reducing the bit length and increasing the number of hidden layer nodes serves to increase the classification accuracy down to a bit length of eight bits. In the example shown in FIG. 4E, reducing the bit length further to four bits serves to decrease the classification accuracy even though more hidden layer nodes are added.

The results shown in FIGS. 4A-4E in which a larger dataset is processed using a larger ANN having a larger memory footprint (when compared to the experiments represented in FIGS. 3A-3E) are broadly consistent with the results shown in FIGS. 3A-3E. The above described finding that using an integer representation to implement an ANN carrying out arithmetic on an ALU increases the accuracy with which measurement data can be classified on a resource constrained sensor device, has therefore also been shown to apply to larger datasets and larger ANNs. Furthermore, reducing the bit length of the integer representation (for example, to a bit length of 8 bits or less) can increase the classification accuracy by allowing the size (i.e. the number of nodes) of the ANN to be increased, even when implementing larger ANNs having a larger memory footprint.

It will be appreciated that the results represented in FIGS. 3A-3E and FIGS. 4A-4E, merely represent examples and should not be construed to limit the scope of the invention as disclosed herein. In other embodiments, different properties such as number of nodes, number of layers of nodes, number of weights and/or bit lengths may be used.

In some embodiments the bit lengths used to represent weights associated with interconnects of an ANN on a sensor device may include a plurality of different bit lengths. For example, a first subset (which may comprise one or more) of the weights may be represented by integers having a first bit length (such as four bits) and a second subset (which may comprise one or more) of the weights may be represented by integers having a second bit length (such as eight bits). For example, one or more weights having a relatively small magnitude (and therefore having a relatively small contribution to the values of the output nodes) may be represented by integers having a relatively small bit length (e.g. four bits). One or more weights having a relatively large magnitude (and therefore having a relatively large contribution to the values of the output nodes) may be represented by integers having a relatively larger bit length (e.g. eight bits).

In some embodiments, in which a plurality of different bit lengths are used, the stored integers (e.g. representing the weights) are ordered in the memory according to the bit lengths of the stored integers. That is, stored integers may be ordered in the memory in the order of the different bit lengths used. For example, integers having a first bit length (such as four bits) may be stored first in the memory followed by integers having a second bit length (such as eight bits). By ordering stored integers according to their bit length, the bit length used to represent an integer may be identified by its position in memory. This may avoid any need to also store the bit length of each integer, in order to identify the bit length of a stored integer. Ordering stored integers in the memory according to the bit lengths of the stored integers may therefore reduce a memory footprint used to store the integers. This may advantageously allow the size of an ANN which can be stored and implemented on a given device to be increased. For example, the number of nodes and/or weights included in the ANN may be increased.

As can be seen for example, from the results shown in FIGS. 3E and 4E, the classification accuracy of an ANN may depend, at least in part, on both the number of nodes used and the bit length of the representation used. The number of nodes, the bit length which is used and/or the number of interconnections used may depend on the particular application and/or the computational resources available. For different applications and/or devices different combinations of ANN size and bit length may provide an increased classification accuracy. In some embodiments, the ratio between the bit length used to represent the weights and the number of hidden layer nodes may be about 1:15 or less.

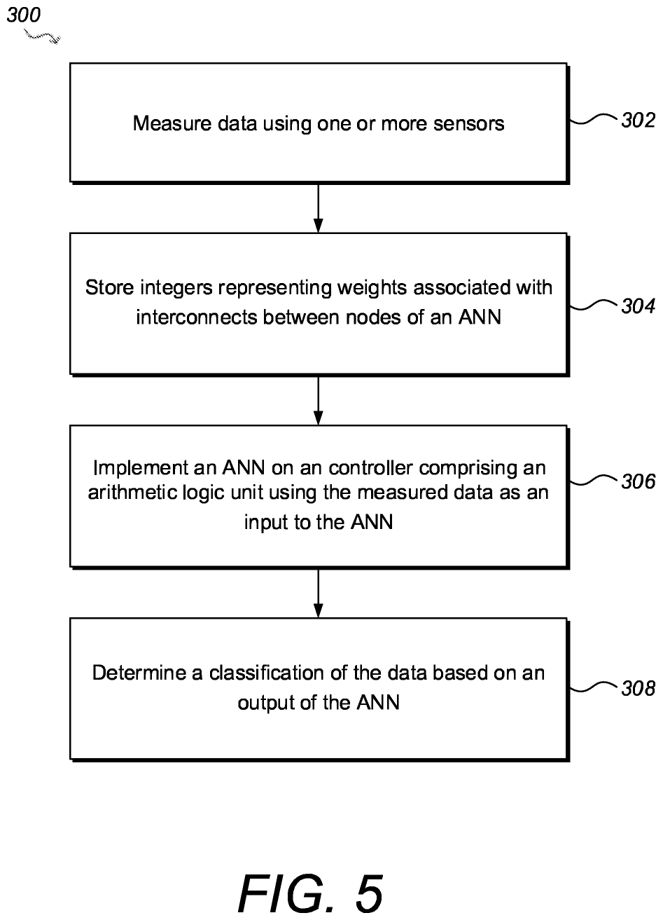

FIG. 5 is a flow-chart representing a method for classifying data on a sensor device 100 according to an embodiment of the invention.

At step 302 data is measured using one or more sensors of the device. The measured data may, for example, be stored in memory on the sensor device 100. At step 304 integers representing weights associated with interconnects between the nodes are stored in memory on the sensor device 100. The weights may, for example, be received from a training device 150 on which the ANN is trained using a training data set.

At step 306 an artificial neural network is implemented on a controller comprising an arithmetic logic unit (ALU). The controller may, for example, pass arithmetic operations for implementing the ANN, to the ALU for computation on the ALU. The implemented ANN comprises a network of interconnected nodes, wherein the stored weights are associated with interconnects between nodes of the ANN.

At step 308 a classification of measurement data is determined based on an output of the ANN. During implementation of the ANN, measurement data output by the one or more sensors is provided as an input to the ANN. The data may, for example, be provided directly from the sensors or may be retrieved from memory of the sensor device 100. The data may be buffered and/or aggregated before being provided as an input to the ANN.

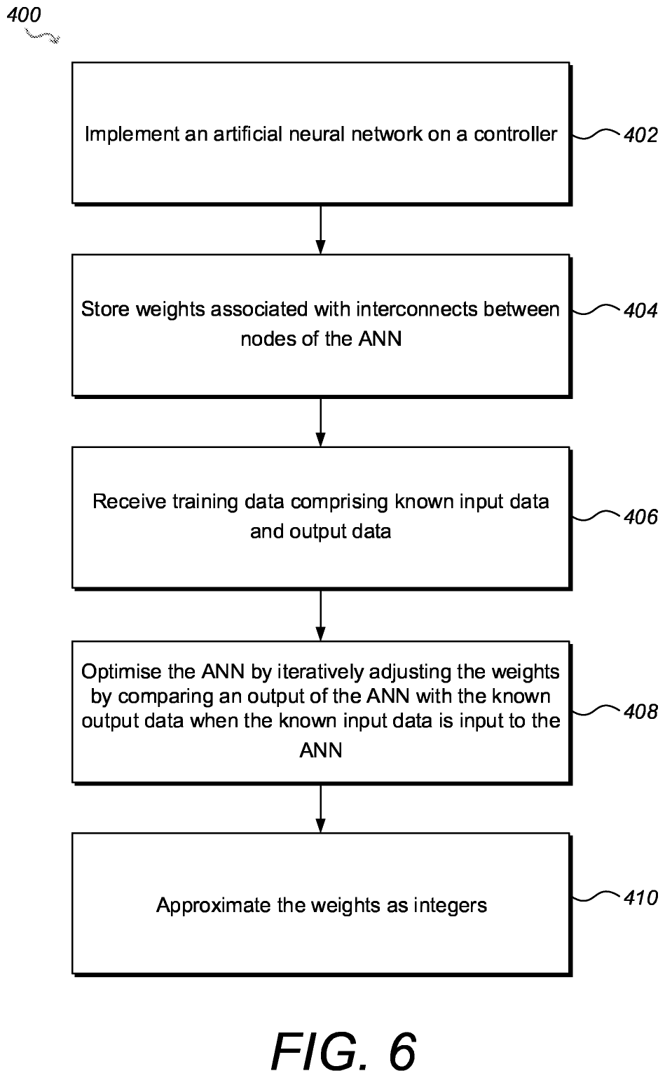

FIG. 6 is a flow-chart representing a method for training an ANN. The method represented in FIG. 6 may be carried out on a training device 150. At step 402, an artificial neural network is implemented on a controller. The controller may, for example, comprise a floating-point unit. The implemented ANN comprises a network of interconnected nodes. At step 404 weights associated with interconnects between the nodes are stored. The weights may, for example, be stored on a memory of a training device 150. For example, the weights may be stored in memory as floating point numbers.

At step 406 training data comprising known input data and output data is received by the controller. The known input data may comprise acquired measurement data representing a known classification. The known output data may comprise the known classification. The known input data is coupled to inputs of the ANN and the ANN may be implemented to output a classification of the input data.

At step 408 the ANN is optimised by iteratively adjusting the weights by comparing an output of the ANN with the known output data. Once the ANN has been optimised, at step 410 the floating-point numbers representing the weights are approximated as integers. These approximated integers may then be used to implement the ANN on the sensor device. The approximated integers may, for example, be communicated to a sensor device.

Various embodiments have been described above in which an ANN is used to classify measurement data output by one or more sensors. It will be appreciated that such an ANN may be used for a wide variety of different uses and in a wide variety of different devices. For example, such an ANN may be implemented in a wearable device such as an activity tracker. Additionally or alternatively an ANN may be implemented in a wearable device for detecting occurrence of one or more events associated with a wearer of the device. For example, the ANN may be for detecting a wearer of the device falling. Such applications may, for example, find use with elderly people or other people prone to falling.

Additionally or alternatively use of an ANN as described herein may find application in sensor devices which form part of a distributed sensor network.

Additionally or alternatively use of an ANN as described herein may find application in an Internet-of-Things device.

Additionally or alternatively use of an ANN as described herein may find application in classifying larger and/or more complex datasets using a larger ANN having a larger memory footprint. For example, sensor data comprising a one or more images may be classified using an ANN as described herein.

Throughout this specification the terms weights and interconnects may be used interchangeably. In general, a weight in an ANN serves as a representation of an interconnect and is therefore associated with an interconnect. References herein to weights in an ANN may be interpreted to refer to an interconnect and its associated weight.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

1-43. (canceled)

44. A sensor device comprising:
one or more sensors configured to measure data;
a controller comprising an arithmetic-logic unit (“ALU”), wherein the controller is configured to cause the ALU to carry out computations for implementing an artificial neural network (“ANN”) comprising a network of interconnected nodes; and
memory coupled to the ALU, and configured to store integers representing weights associated with interconnects between the nodes;
wherein the controller is operable to implement the ANN to:
receive data measured by the one or more sensors; and
determine a classification of the data based on the network of interconnected nodes and the weights associated with the interconnects.

45. The sensor device of claim 44, wherein the stored integers representing the weights associated with interconnects between the nodes have a bit length of thirty two bits or less.

46. The sensor device of claim 45, wherein the stored integers representing the weights associated with interconnects between the nodes have a bit length of eight bits or less.

47. The sensor device of claim 44, wherein the stored integers representing the weights associated with interconnects between the nodes have a bit length of more than two bits.

48. The sensor device of claim 44 wherein the stored integers are static during implementation of the ANN.

49. The sensor device of claim 44 wherein the interconnects are static during implementation of the ANN.

50. The sensor device of claim 44 wherein the stored integers are determined based on weights computed by an external device on which the ANN is trained.

51. The sensor device of claim 44 wherein the interconnected nodes comprise:
an input layer of nodes;
an output layer of nodes; and
one or more hidden layers of nodes situated between the input layer of nodes and the output layer of nodes.

52. The sensor device of claim 51 wherein the ratio between the bit length of the stored integers representing the weights associated with the interconnects and the number of hidden layer nodes is 1:15 or less.

53. The sensor device of claim 44 wherein the bit lengths of the stored integers representing the weights associated with interconnects between the nodes includes a plurality of different bit lengths.

54. The sensor device of claim 53, wherein the stored integers are ordered in the memory according to the bit length of the stored integers.

55. The sensor device of claim 44 wherein the device is a wearable device.

56. The sensor device of claim 44 comprising communication means to transmit the determined classification of the data to an external device.

57. The sensor device of claim 44 wherein the device is an Internet-of-Things device.

58. A training device comprising:
a controller configured to carry out computations for implementing an artificial neural network (“ANN”) comprising a network of interconnected nodes; and
memory coupled to the controller, to store weights associated with interconnects between the nodes;
wherein the controller is operable to:
receive training data comprising input data and known output data;
optimise the ANN by iteratively adjusting the weights by comparing an output of the ANN with the known output data when the known input data is input to the ANN; and
approximate the weights as integers.

59. The training device of claim 58, wherein the integers have a bit length of thirty two bits or less.

60. The training device of claim 58, wherein bit lengths of the integers representing the weights associated with interconnects between the nodes includes a plurality of different bit lengths.

61. The training device of claim 58, further comprising communication means to transmit the determined weights to a sensor device.

62. The training device of claim 58, wherein the controller comprises a floating point unit (“FPU”), and wherein the controller is configured to cause the FPU to carry out the computations for implementing the ANN.

63. A method for classifying data on a sensor device comprising one or more sensors, the method comprising:
measuring data using the one or more sensors;
implementing an artificial neural network (“ANN”) on a controller comprising an arithmetic logic unit (“ALU”), the ANN comprising a network of interconnected nodes, wherein the implementing comprises carrying out computations for implementing the ANN on the ALU;
storing integers representing weights associated with interconnects between the nodes; and
determining a classification of the data based on the network of interconnected nodes and weights associated with the interconnects.
